(19) United States
(12) Patent Application Publication
(10) Pub. No.: US 2026/0180204 A1
(43) Pub. Date: Jun. 25, 2026

(54) ANTENNA MODULE AND COMMUNICATION DEVICE INCLUDING THE SAME

(71) Applicant: Murata Manufacturing Co., Ltd., Nagaokakyo-shi (JP)

(72) Inventors: Kouta ARAI, Nagaokakyo-shi (JP); Ryo KOMURA, Nagaokakyo-shi (JP); Norikazu FUJII, Nagaokakyo-shi (JP); Hirotsugu MORI, Nagaokakyo-shi (JP); Kazushige SATO, Nagaokakyo-shi (JP)

(73) Assignee: Murata Manufacturing Co., Ltd., Nagaokakyo-shi (JP)

(21) Appl. No.: 19/542,716

(22) Filed: Feb. 18, 2026

Related U.S. Application Data
(63) Continuation of application No. PCT/JP2024/021011, filed on Jun. 10, 2024.

(30) Foreign Application Priority Data
Aug. 24, 2023 (JP) 2023-136253

(51) Int. Cl. H01Q 21/06; H01Q 9/04

(52) U.S. Cl. CPC H01Q 21/065; H01Q 9/0407

(57) ABSTRACT

An antenna module includes a substrate, a ground electrode, a first subarray of patch antennas disposed on a first main side of the ground electrode. Feed circuitry is disposed on a second side of the ground electrode and connected to the first subarray via a feed line A signal line connects the feed circuit and an external connection terminal. When viewed in plan in a first direction normal to the substrate, the external connection terminal does not overlap the first subarray or the feed circuit. When viewed in plan in a second direction orthogonal to the first direction, at least a part of the signal line is between one or more of the plurality of patch antennas and the ground electrode. When viewed in plan in the first direction, the signal line does not overlap the first subarray.

### CROSS-REFERENCE TO RELATED APPLICATIONS

This application is a continuation of International Application No. PCT/JP2024/021011, filed on Jun. 10, 2024, which claims priority to Japanese Patent Application No. 2023-136253, filed on Aug. 24, 2023. The entire contents of each of these applications are incorporated herein by reference.

### TECHNICAL FIELD

The present disclosure relates to an antenna module and a communication device including the same. More specifically, the present disclosure relates to a technique for suppressing degradation of antenna characteristics.

### BACKGROUND ART

A typical antenna module includes a substrate, and a radiating element and various electronic components mounted on or in the substrate. A representative example of such electronic components may be a radio frequency integrated circuit (RFIC) and a baseband integrated circuit (BBIC).

For example, International Publication No. WO2023/100621 (Patent Document 1) discloses an antenna module that includes a substrate having patch antennas and that includes a signal line disposed between an external connection terminal and an RFIC. The patch antennas and the RFIC are connected to each other by a feed line. The RFIC functions as a feed circuit for the patch antennas. A BBIC-mounted motherboard is connected to the external connection terminal. The feed circuit (RFIC) and the BBIC communicate with each other through the signal line.

### Citation List

### Patent Document

Patent Document 1: International Publication No. WO2023/100621

### SUMMARY

An antenna module according to the present disclosure includes a substrate, a ground electrode opposed to a first main surface and a second main surface opposed to each other of the substrate, a first subarray opposed to the ground electrode and disposed on the first main surface side relative to the ground electrode, a feed circuit disposed on the second main surface side relative to the ground electrode, a feed line connecting the feed circuit and the first subarray, an external connection terminal, and a signal line connecting the feed circuit and the external connection terminal. The first subarray is constituted by a plurality of patch antennas. When viewed in plan in a first direction which is a normal direction of the substrate, the external connection terminal is disposed at a position that does not overlap the first subarray or the feed circuit. When viewed in plan in a second direction orthogonal to the first direction, at least a part of the signal line is disposed between one or more of the plurality of patch antennas and the ground electrode. When viewed in plan in the first direction, the signal line does not overlap the first subarray.

### BRIEF DESCRIPTION OF DRAWINGS

FIG. 1 is a block diagram of a communication device to which an antenna module according to a first embodiment is applied.

FIG. 2 includes a plan view and a side perspective view of the antenna module illustrated in FIG. 1.

FIG. 3 is a diagram illustrating a first modification of the antenna module according to the first embodiment.

FIG. 4 is a diagram illustrating a second modification of the antenna module according to the first embodiment.

FIG. 5 is a plan view of an antenna module according to a second embodiment.

FIG. 6 is a diagram illustrating a wiring manner of feed lines applied to the antenna module illustrated in FIG. 5.

FIG. 7 is a diagram illustrating a modification of the antenna module according to the second embodiment.

FIG. 8 is a diagram illustrating a wiring manner of feed lines applied to the antenna module illustrated in FIG. 7.

### DESCRIPTION OF EMBODIMENTS

Hereinafter, embodiments of the present disclosure will be described in detail with reference to the drawings. The same or equivalent components in the drawings are denoted by the same reference numerals, and the description thereof is not repeated.

In the development of compact antenna modules, the inventors have observed that when a signal line connecting an external connection terminal and a feed circuit is placed in close proximity to a patch antenna, the magnetic field generated around the signal line can interfere with the antenna's radiation pattern. This interference may cause directivity distortion, where the beam is tilted or distorted away from the intended direction. Specifically, the magnetic field generated by signal lines carrying relatively low-frequency signals (e.g., baseband or control signals) can induce unwanted currents in the patch antennas located directly above or below the signal line.

Embodiments of the present disclosure are directed to solving these and other problems by arranging the signal lines in a specific three-dimensional relationship with the antenna subarrays. By placing the signal lines in the dielectric space between the ground plane and the antennas—but ensuring there is no vertical overlap between the signal lines and the subarrays—the module achieves a significantly reduced profile (thinness) while maintaining high beam directivity and signal integrity.

### First Embodiment

### Basic Configuration of Communication Device

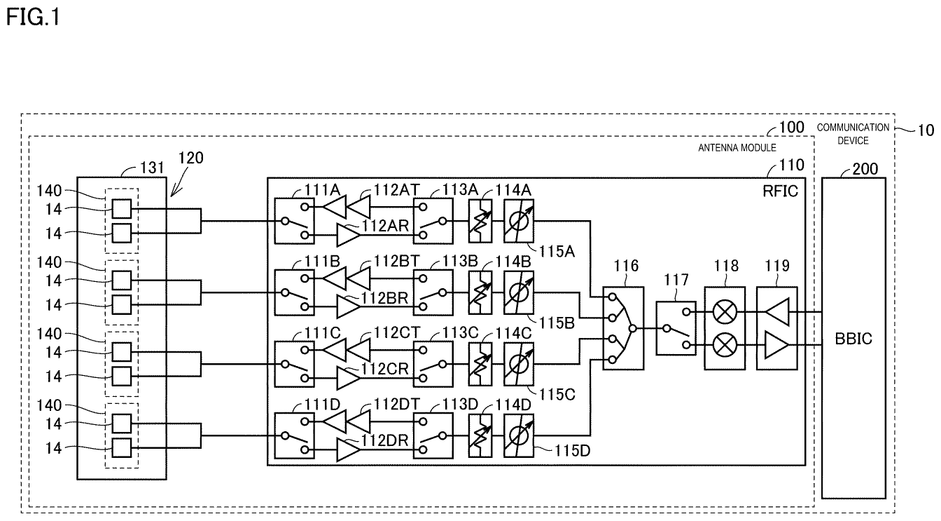

FIG. 1 is an example of a block diagram of a communication device 10 to which an antenna module 100 according to a first embodiment is applied. The communication device 10 is, for example, a mobile terminal such as a mobile phone, a smartphone, or a tablet, or a personal computer having a communication function. The frequency band of a radio wave used in the antenna module 100 according to the first embodiment is, for example, a millimeter-wave band having a center frequency of, for example, 28 GHz or 60 GHz. A radio wave in another frequency band is also applicable to the antenna module according to the present disclosure.

Referring to FIG. 1, the communication device 10 includes the antenna module 100 and a baseband integrated circuit (BBIC) 200 constituting a baseband signal processing circuit. The antenna module 100 includes a radio frequency integrated circuit (RFIC) 110 and an antenna device 120. The RFIC 110 is an example of a feed circuit. The functionality of the elements disclosed herein, e.g., the feed circuit, may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. The hardware may be any hardware disclosed herein which is programmed or configured to carry out the recited functionality.

The communication device 10 up-converts, by the RFIC 110, a signal transferred from the BBIC 200 to the antenna module 100 into a radio frequency (RF) signal, and radiates the RF signal from the antenna device 120. The communication device 10 transmits an RF signal received by the antenna device 120 to the RFIC 110, down-converts the RF signal, and processes the signal by the BBIC 200.

The antenna device 120 includes a dielectric substrate 131 and a plurality of patch antennas 14. In the present embodiment, a combination of two or more patch antennas 14 constitutes one antenna that exhibits a pre-designed directivity. Such an antenna will be hereinafter referred to as a “subarray”. Here, a subarray 140 constituted by a combination of two patch antennas 14 is illustrated as a subarray.

The dielectric substrate 131 is provided with a plurality of subarrays 140. FIG. 1 illustrates four subarrays 140 as an example of a plurality of subarrays 140.

Feed lines provided for the respective subarrays 140 are connected to the RFIC 110. Each of the feed lines extending from the RFIC 110 toward the respective subarrays 140 branches into two lines, which are connected to the two patch antennas 14 of a corresponding one of the subarrays 140.

The number of subarrays 140 disposed on or in the dielectric substrate 131 is not limited to four. It suffices that one or more subarrays 140 be disposed in the dielectric substrate 131. The number of patch antennas 14 included in each subarray 140 is not limited to two. It suffices that the subarray 140 include two or more patch antennas 14.

The RFIC 110 includes switches 111A to 111D, 113A to 113D, and 117; power amplifiers 112AT to 112DT; low-noise amplifiers 112AR to 112DR; attenuators 114A to 114D; phase shifters 115A to 115D; a signal combiner/splitter 116; a mixer 118; and an amplifier circuit 119.

In the case of transmitting an RF signal, the switches 111A to 111D and 113A to 113D are switched to the power amplifiers 112AT to 112DT side, and the switch 117 is connected to a transmission-side amplifier of the amplifier circuit 119. In the case of receiving an RF signal, the switches 111A to 111D and 113A to 113D are switched to the low-noise amplifiers 112AR to 112DR side, and the switch 117 is connected to a reception-side amplifier of the amplifier circuit 119.

A signal transferred from the BBIC 200 to the RFIC 110 is amplified by the amplifier circuit 119 and is up-converted by the mixer 118. A transmission signal, which is an up-converted RF signal, is split into four transmission signals by the signal combiner/splitter 116, and the four transmission signals are fed to the respective subarrays 140 through four respective signal paths. At this time, the directivity of the antenna device 120 can be adjusted by individually adjusting the phase shift amounts of the phase shifters 115A to 115D disposed in the respective signal paths. The attenuators 114A to 114D each adjust the intensity of a corresponding one of the transmission signals.

Reception signals, which are RF signals received by the respective subarrays 140, pass through the four different signal paths and are combined into a reception signal by the signal combiner/splitter 116. The reception signal is down-converted by the mixer 118, is amplified by the amplifier circuit 119, and is transferred to the BBIC 200.

The RFIC 110 is, for example, formed as a single-chip integrated circuit component having the above-described circuit configuration. The RFIC 110 may be formed as single-chip integrated circuit components each of which is for a corresponding one of sets of devices (switch, power amplifier, low-noise amplifier, attenuator, and phase shifter) for the individual subarrays 140.

### Configuration of Antenna Module

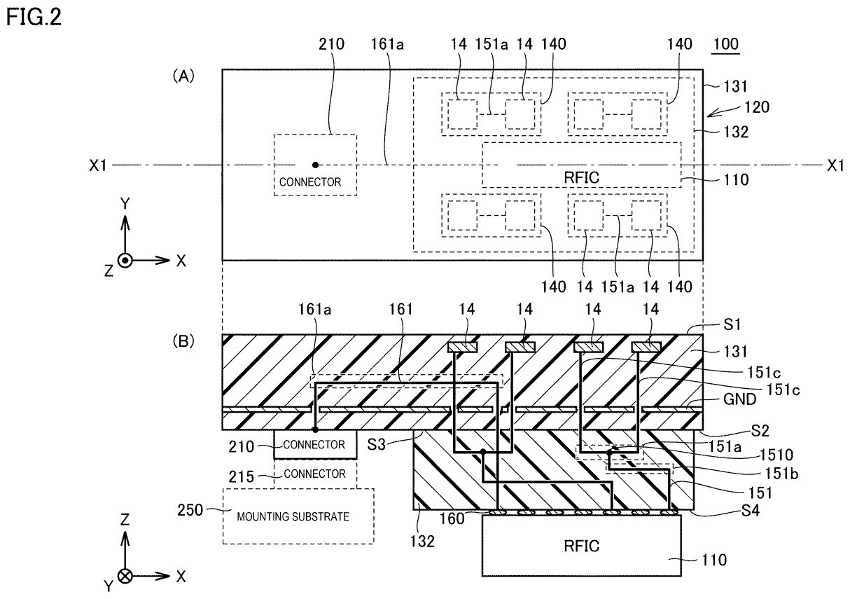

Next, the configuration of the antenna module 100 according to the first embodiment will be described in detail with reference to FIG. 2. FIG. 2 includes a plan view and a side perspective view of the antenna module 100 illustrated in FIG. 1. In FIG. 2, a plan view of the antenna module 100 (FIG. 2(A)) is illustrated in the upper part, and a side perspective view thereof (FIG. 2(B)) is illustrated in the lower part.

The antenna module 100 includes the dielectric substrate 131 where the subarrays 140 are mounted, and a dielectric substrate 132 where the RFIC 110 is mounted. The dielectric substrates 131 and 132 each have a rectangular shape when viewed in plan in the normal direction.

The dielectric substrate 131 has a substrate surface S1 and a substrate surface S2 opposed to each other. The dielectric substrate 132 and a connector 210 are disposed on the substrate surface S2 of the dielectric substrate 131. A substrate surface S3 of the dielectric substrate 132 is joined to the substrate surface S2 of the dielectric substrate 131. Thus, the substrate surface S2 of the dielectric substrate 131 and the substrate surface S3 of the dielectric substrate 132 are opposed to each other. The RFIC 110 is disposed on a substrate surface S4 of the dielectric substrate 132. The RFIC 110 is connected to the substrate surface S4 of the dielectric substrate 132 by a plurality of solder bumps 160. The RFIC 110 may be connected to the dielectric substrate 132 by a multipolar connector disposed on the substrate surface S4.

In the following description, the normal direction of the dielectric substrate 131 is defined as a Z-axis direction. In a plane perpendicular to the Z-axis direction, the direction in which the connector 210 and the RFIC 110 are arranged is defined as an X-axis, and the direction orthogonal to the X-axis is defined as a Y-axis.

The patch antennas 14 constituting each subarray 140 are each a flat electrode having a rectangular shape. The subarrays 140 are disposed on, of the substrate surface S1 and the substrate surface S2 of the dielectric substrate 131, the substrate surface S1 side. The subarrays 140 are disposed inside the dielectric substrate 131. The subarrays 140 may be disposed on or in the dielectric substrate 131 such that the subarrays 140 are exposed on the substrate surface S1.

A ground electrode GND is disposed inside the dielectric substrate 131. The ground electrode GND is disposed in the dielectric substrate 131 so as to cover the substantially entire region of a flat plane including the X-axis and the Y-axis in the dielectric substrate 131. The ground electrode GND is opposed to the individual subarrays 140 in the normal direction of the dielectric substrate 131.

RF signals are supplied to the subarrays 140 from the RFIC 110 through feed lines 151. The feed lines 151 are each an example of a feed line for supplying an RF signal output from a feed circuit (RFIC 110) to the subarray. Each feed line 151 connected to the RFIC 110 branches into two branch lines 151c at a branch point 1510 in the dielectric substrate 132. The branch lines 151c extend through the ground electrode GND in the dielectric substrate 131 and are connected to feed points of the two patch antennas 14 constituting a corresponding one of the subarrays 140. The feed line 151 includes in-plane wiring portions 151a and 151b that are parallel to the substrate surfaces S3 and S4 of the dielectric substrate 132. The in-plane wiring portion 151a constitutes a part of the branch lines 151c. The in-plane wiring portions 151a and 151b are disposed in the dielectric substrate 132 so as to be parallel to the X-axis.

A mounting substrate 250 is connected to the connector 210. The mounting substrate 250 has a connector 215 attached thereto. The connector 215 of the mounting substrate 250 is connected to the connector 210, and thereby the mounting substrate 250 is attached to the dielectric substrate 131.

The connector 210 and the RFIC 110 are electrically connected to each other by a signal line 161. The mounting substrate 250 communicates with the RFIC 110 through the signal line 161. The signal line 161 includes an in-plane wiring portion 161a that is parallel to the substrate surfaces S1 and S2 of the dielectric substrate 131. The in-plane wiring portion 161a is disposed in the dielectric substrate 131 so as to be parallel to the X-axis. A wiring line extending from the connector 210 in the normal direction of the dielectric substrate 131 is connected to one end of the in-plane wiring portion 161a. The other end of the in-plane wiring portion 161a is connected to a wiring line extending from the RFIC 110 in the normal direction of the dielectric substrates 131 and 132.

When the dielectric substrate 131 is viewed in plan, each subarray 140 is disposed in the dielectric substrate 131 at such an angle that the two patch antennas 14 included in the subarray 140 are parallel to the X-axis. When the dielectric substrate 131 is viewed in plan, the plurality of subarrays 140 are disposed in matrix in the dielectric substrate 131.

### Definition of Subarray

Now, a “subarray” will be defined. The subarray 140 includes a plurality of patch antennas 14. The subarray 140 may be configured such that each of the plurality of patch antennas 14 is connected to a branch line that branches out from a single feed line extending from the feed circuit (RFIC 110). Such a configuration is illustrated in FIG. 2. In this configuration, the feed line branches outside the RFIC 110. Alternatively, the feed line may branch inside the RFIC 110, and branch lines for the plurality of patch antennas 14 may extend from the RFIC 110. In this case, the feed line that branches inside the RFIC 110 may be connected to a single signal source in the RFIC 110.

As described above, the plurality of patch antennas 14 constituting the subarray 140 are supplied with a signal from a single signal source of the feed circuit, and the line for supplying the signal includes branch lines that branch out from the signal source. The branch point 1510 of the line for supplying the signal may be present inside the RFIC 110 or outside the RFIC 110.

### Regarding Disposition of Signal Line

As illustrated in FIG. 2(B), when the dielectric substrate 131 is viewed in the Y-axis direction, the in-plane wiring portion 161a of the signal line 161 is disposed between the ground electrode GND and the plurality of patch antennas 14. Thus, the space between the ground electrode GND and the plurality of patch antennas 14 in the dielectric substrate 131 is effectively used as a wiring space for the signal line 161. As a result, the profile of the antenna module 100 can be reduced as compared with the case of further providing a wiring space for the in-plane wiring portion 161a in the dielectric substrate 131 or the like.

In such case where at least a part of the signal line 161 is disposed between the ground electrode GND and the plurality of patch antennas 14, an influence of a magnetic field generated around the signal line 161 should be considered. This is because, when the signal line 161 is disposed close to the patch antennas 14, a magnetic field generated around the signal line causes deterioration of antenna directivity. The deterioration of directivity is significant in the antenna module 100 employing the subarrays 140 each constituted by a plurality of patch antennas 14. This is because, when the patch antennas 14 with deteriorated directivity are formed into a subarray, the entire subarray 140 exhibits directivity distortion.

When the in-plane wiring portion 161a of the signal line 161 is disposed at a position that overlaps the plurality of patch antennas 14 constituting the subarray 140 in plan view in the normal direction of the dielectric substrate 131, the distance between the signal line 161 and the patch antennas 14 is short. Alternatively, when the in-plane wiring portion 161a of the signal line 161 is disposed between the plurality of patch antennas 14 constituting the subarray 140 in plan view in the normal direction of the dielectric substrate 131, the distance between the signal line 161 and the patch antennas 14 is short.

Accordingly, in the present embodiment, measures are taken to avoid the signal line 161 being close to the patch antennas 14. That is, in the present embodiment, when viewed in plan in the normal direction of the dielectric substrate 131, the in-plane wiring portion 161a of the signal line 161 is not disposed at a position that overlaps the plurality of patch antennas 14 constituting the subarray 140. As illustrated in FIG. 2(A), the in-plane wiring portion 161a of the signal line 161 overlaps an X1-X1 line. The subarrays 140 are disposed on both sides of the X1-X1 line.

Furthermore, in the present embodiment, the in-plane wiring portion 161a of the signal line 161 is not disposed between the plurality of patch antennas 14 constituting the subarray 140. For example, as illustrated in FIG. 2(A), the in-plane wiring portion 151a of the feed line 151 is disposed between the plurality of patch antennas 14 constituting the subarray 140, but the in-plane wiring portion 161a of the signal line 161 does not intersect the in-plane wiring portion 151a of the feed line 151.

Thus, in the present embodiment, the signal line 161 is not close to the patch antennas 14. As a result, deterioration of directivity of the plurality of patch antennas 14 constituting the subarray 140 can be reduced, and distortion of directivity of the subarray 140 can be suppressed.

Features regarding the above-described disposition of the signal line are implemented by the configuration in the present embodiment described below. That is, the ground electrode GND is opposed to the substrate surface S1 and the substrate surface S2 opposed to each other of the dielectric substrate 131. The subarrays 140 that radiate radio waves are opposed to the ground electrode GND and are disposed on the substrate surface S1 side relative to the ground electrode GND. The RFIC 110 that supplies RF signals to the subarrays 140 is disposed on the substrate surface S2 side relative to the ground electrode GND. In the dielectric substrates 131 and 132, the feed lines 151 connecting the signal source of the RFIC 110 and the subarrays 140 are disposed. In the dielectric substrates 131 and 132, the signal line 161 connecting the RFIC 110 and the connector 210 is disposed.

Each subarray 140 is constituted by a plurality of patch antennas 14. The RFIC 110 supplies an RF signal to each of the plurality of patch antennas 14. When viewed in plan in the normal direction of the dielectric substrate 131, the connector 210 is disposed at a position that does not overlap the subarrays 140 or the RFIC 110.

When viewed in plan in the direction orthogonal to the normal direction of the dielectric substrate 131 (in the Y-axis direction), the in-plane wiring portion 161a constituting at least a part of the signal line 161 is disposed between one or more of the plurality of patch antennas 14 and the ground electrode GND. FIG. 2(B) illustrates an example in which the in-plane wiring portion 161a is disposed between one patch antenna 14 and the ground electrode GND. Alternatively, the in-plane wiring portion 161a may be extended in the X-axis direction so as to be disposed between two or more patch antennas 14 and the ground electrode GND.

When viewed in plan in the normal direction of the dielectric substrate 131, the in-plane wiring portion 161a of the signal line 161 does not overlap any subarray 140. To be more specific, when viewed in plan in the normal direction of the dielectric substrate 131, the in-plane wiring portion 161a of the signal line 161 is not disposed at a position that overlaps the plurality of patch antennas 14 constituting the subarray 140 and is not disposed between the plurality of patch antennas 14 constituting the subarray 140.

The substrate surface S1 is an example of a first main surface, and the substrate surface S2 is an example of a second main surface. The RFIC 110 is an example of a feed circuit, and the connector 210 is an example of an external connection terminal.

### Regarding Relationship Between Signal in Signal Line and Signal in Feed Line

An RF signal that flows through the feed line 151 is a signal of a frequency band supported by the patch antennas 14. The frequency band is, for example, a frequency band having a center frequency of, for example, 28 GHz or 60 GHz. The frequency band of a signal that flows through the signal line 161 varies according to the type of the mounting substrate 250 connected to the connector 210.

The mounting substrate 250 may have, for example, any of a BBIC, a local oscillator circuit, a control circuit, and a power supply circuit. The mounting substrate 250 may further have an antenna module in addition to the foregoing circuit. However, the mounting substrate 250 may have no antenna module in consideration of the directivity of the subarrays 140. The reason will be described below.

A BB signal is output from the BBIC to the signal line 161. A local signal is output from the local oscillator circuit to the signal line 161. A control signal is output from the control circuit and the power supply circuit to the signal line 161.

The frequency band of the BB signal is about 100 MHz to 1 GHz. The frequency band of the local signal is about 28 GHz or about 500 MHz to 10 GHz. The frequency band of the control signal is about 100 MHz.

To suppress degradation of the directivity of the subarrays 140, a circuit to be mounted on or in the mounting substrate 250 may be selected so that the frequency band of a signal that flows through the signal line 161 is lower than the frequency band of a signal that flows through the feed line 151. From this point of view, an antenna module that functions in a frequency band that is the same as or higher than the frequency band of the patch antennas 14 may not be mounted on or in the mounting substrate 250.

If the mounting substrate 250 having an antenna module is connected to the connector 210, an RF signal flows through the signal line 161 from the mounting substrate 250. For example, when the frequency band of the RF signal flowing through the signal line 161 is the same as the frequency band of the patch antennas 14, resonance occurs, and isolation between the patch antennas 14 and a radiating element of the antenna module mounted on or in the mounting substrate 250 degrades. As a result, the directivity of the subarrays 140 degrades.

Accordingly, in the present embodiment, the type of the mounting substrate 250 connected to the connector 210 may be selected so that the frequency band of a signal that flows through the signal line 161 is lower than the frequency band of a signal that flows through the feed line 151. This makes it possible to prevent an RF signal having a negative influence on the directivity of the subarrays 140 from flowing through the signal line 161.

To be more specific, a configuration may be designed so that the above-described BB signal, local signal, control signal, and so forth flow through the signal line 161. Accordingly, the frequency band of a signal that flows through the signal line 161 is lower than the frequency band supported by the patch antennas 14.

### Regarding Positional Relationship Between Signal Line 161 and Subarrays 140

As illustrated in FIG. 2(A), the antenna module 100 includes a plurality of subarrays 140. When viewed in plan in the normal direction of the dielectric substrate 131, the subarrays 140 are disposed on both sides of the signal line 161 (the in-plane wiring portion 161a) and the X1-X1 line that is on the extension of the signal line 161 (the in-plane wiring portion 161a). That is, when viewed in plan in the normal direction of the dielectric substrate 131, the signal line 161 is disposed between subarrays 140 and subarrays 140.

If the plurality of subarrays 140 are disposed in only one of the two regions on both sides of the signal line 161, radio waves are difficult to propagate to the signal line 161 side, and thus the directivity of the entire array antenna degrades (the directivity deviates from the zenith direction of the substrate). In contrast, when the subarrays 140 are disposed in both the two regions on both sides of the signal line 161 as in the present embodiment, the signal line 161 has an influence on the subarrays 140 on both sides of the signal line 161, and thus degradation of the directivity of the entire array antenna (deviation of the directivity from the zenith direction of the substrate) can be suppressed.

In FIG. 2(A), the two patch antennas 14 constituting the subarray 140 are arranged in the X-axis direction and constitute a “1×2” matrix. Alternatively, the two patch antennas 14 constituting the subarray 140 may be arranged in the Y-axis direction to form a “2×1” matrix. Alternatively, three or more patch antennas 14 may constitute the subarray 140. For example, a subarray 140 in which a plurality of patch antennas 14 constitute a “2×2” or “2×4” matrix may be employed.

### Regarding Dielectric Loss Tangents of Dielectric Substrates 131 and 132

The dielectric substrates 131 and 132 are implemented by various types of substrates. The various types of substrates include, for example, (1) a low temperature co-fired ceramics (LTCC) multilayer substrate, (2) a resin multilayer substrate formed by laminating a plurality of resin layers composed of a resin such as epoxy or polyimide, (3) a resin multilayer substrate formed by laminating a plurality of resin layers composed of liquid crystal polymer (LCP) having a lower permittivity, (4) a resin multilayer substrate formed by laminating a plurality of resin layers composed of fluorine resin, (5) a resin multilayer substrate formed by laminating a plurality of resin layers composed of polyethylene terephthalate (PET), and (6) a ceramic multilayer substrate other than an LTCC multilayer substrate.

The dielectric substrates 131 and 132 may be the same type of substrates or different types of substrates. However, the dielectric loss tangent of the dielectric substrate 132 may be lower than the dielectric loss tangent of the dielectric substrate 131. The reason will be described below.

As illustrated in FIG. 2(B), the dielectric substrate 132 includes the branch point 1510 at which the feed line 151 branches. It is typically difficult to achieve impedance matching at a branch point of a signal line, and thus matching loss is prone to occur at the branch point. To reduce matching loss at the branch point, it is effective to decrease the dielectric loss tangent of the dielectric substrate 132 including the branch point. Thus, to reduce matching loss at the branch point, the dielectric loss tangent of the dielectric substrate 132 may be lower than the dielectric loss tangent of the dielectric substrate 131.

A PCB (FR-4) standard FR-4 substrate is an example of a substrate having a high dielectric loss tangent. An LTCC multilayer substrate is an example of a substrate having a lower dielectric loss tangent than the PCB (FR-4) standard FR-4 substrate.

The dielectric substrate 131 and the dielectric substrate 132 may be constituted by a single substrate. In this case, the substrate may have two layers whose boundary is a portion corresponding to a boundary between the dielectric substrate 131 and the dielectric substrate 132 (a boundary portion between the substrate surface S2 and the substrate surface S3) when viewed in plan in the Y-axis direction, and the substrate layer including the ground electrode GND and the substrate layer including the branch point 1510 of the feed line 151 may have dielectric loss tangents different from each other. To reduce matching loss at the branch point 1510, the dielectric loss tangent of the substrate layer including the branch point 1510 of the feed line 151 may be lower than the dielectric loss tangent of the substrate layer including the ground electrode GND.

Features regarding the above-described dielectric loss tangent are implemented by the configuration in the present embodiment described below. That is, the feed line 151 includes the branch lines 151c that branch out at the branch point 1510. The branch point 1510 is disposed in the dielectric substrate 132. In other words, the branch point 1510 is located on the substrate surface side relative to the ground electrode GND. The dielectric loss tangent of the dielectric substrate 132 is lower than the dielectric loss tangent of the dielectric substrate 131 where the ground electrode GND is disposed. In other words, the dielectric loss tangent is lower on the substrate surface S2 side than on the substrate surface S1 side relative to the ground electrode GND.

### Relationship Between Signal Line 161 and Branch Lines 151c

As illustrated in FIG. 2(A), when the dielectric substrate 131 is viewed in plan, the branch lines 151c of the feed line 151 do not overlap the signal line 161 (the in-plane wiring portion 161a).

Accordingly, the distance between the feed line 151 and the signal line 161 can be increased as compared with a case where the branch lines 151c of the feed line 151 overlap the signal line 161 (the in-plane wiring portion 161a). As a result, it is possible to suppress the occurrence of electromagnetic coupling between a signal flowing through the feed line 151 and a signal flowing through the signal line 161. Accordingly, degradation of the directivity of the subarray 140 can be suppressed.

### Relationship 1 Between In-Plane Wiring Portion 161a and In-Plane Wiring Portions 151a and 151b

As illustrated in FIG. 2(B), the signal line 161 includes the in-plane wiring portion 161a disposed to extend in the X-axis direction, and the feed line 151 includes the in-plane wiring portions 151a and 151b disposed to extend in the X-axis direction. As illustrated in FIG. 2(A), when the dielectric substrate 131 is viewed in plan, the in-plane wiring portion 161a of the signal line 161 and the in-plane wiring portions 151a and 151b of the feed line 151 do not overlap each other.

Accordingly, when the dielectric substrate 131 is viewed in plan, the distance between the feed line 151 and the signal line 161 can be increased as compared with a case where the in-plane wiring portion 161a of the signal line 161 and the in-plane wiring portions 151a and 151b of the feed line 151 overlap each other. As a result, it is possible to suppress the occurrence of electromagnetic coupling between a signal flowing through the feed line 151 and a signal flowing through the signal line 161.

The in-plane wiring portion 161a and the in-plane wiring portions 151a and 151b extend in parallel to the X-axis along an XY plane including the X-axis and the Y-axis. In contrast, a via wiring portion disposed to extend through the substrate layers of the dielectric substrates 131 and 132, such as the branch lines 151c, extends perpendicularly to the XY plane. Thus, the electromagnetic coupling force between a signal flowing through the in-plane wiring portion 161a and a signal flowing through the in-plane wiring portions 151a and 151b is greater than the electromagnetic coupling force between a signal flowing through the in-plane wiring portion 161a and a signal flowing through the via wiring portion (for example, the branch lines 151c).

In the present embodiment, the in-plane wiring portion 161a and the in-plane wiring portions 151a and 151b that are prone to electromagnetically couple with each other are arranged so as not to overlap each other when the dielectric substrate 131 is viewed in plan. Thus, electromagnetic coupling can be reduced more effectively.

### Relationship 2 Between In-Plane Wiring Portion 161a and In-Plane Wiring Portions 151a and 151b

As illustrated in FIG. 2(B), when viewed in plan in the direction orthogonal to the normal direction of the dielectric substrate 131 (in the Y-axis direction), the ground electrode GND is disposed between the in-plane wiring portion 161a of the signal line 161 and the in-plane wiring portions 151a and 151b of the feed line 151.

As described above, electromagnetic coupling is more prone to occur between a signal flowing through the in-plane wiring portion 161a and a signal flowing through the in-plane wiring portions 151a and 151b than between a signal flowing through the in-plane wiring portion 161a and a signal flowing through the via wiring portion (for example, the branch lines 151c).

In the present embodiment, the ground electrode GND is disposed between the in-plane wiring portion 161a and the in-plane wiring portions 151a and 151b that are prone to electromagnetic coupling. Thus, electromagnetic coupling can be reduced more effectively.

### First Modification

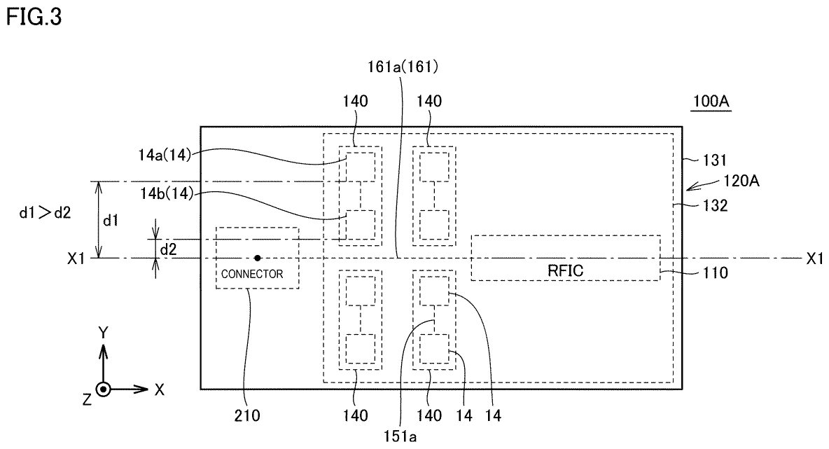

Next, a first modification of the first embodiment will be described. FIG. 3 is a diagram illustrating the first modification of the antenna module 100 according to the first embodiment. An antenna module 100A according to the first modification includes the RFIC 110 and an antenna device 120A.

In the antenna module 100A according to the first modification, the two patch antennas 14 constituting the subarray 140 are arranged in the Y-axis direction, as illustrated in FIG. 3. Here, to distinguish the two patch antennas 14 constituting the subarray 140, one patch antenna 14 is referred to as a “patch antenna 14a” and the other patch antenna 14 is referred to as a “patch antenna 14b”. The antenna module 100A has a configuration similar to that of the antenna module 100 except that the patch antennas 14a and 14b are arranged in the Y-axis direction.

As illustrated in FIG. 3, when the dielectric substrate 131 is viewed in plan, a distance d1 between the patch antenna 14a and the signal line 161 (the in-plane wiring portion 161a) is greater than a distance d2 between the patch antenna 14b and the signal line 161 (the in-plane wiring portion 161a). Thus, an influence of a signal flowing through the signal line 161 on the performance of the patch antenna 14a can be made smaller than an influence of a signal flowing through the signal line 161 on the performance of the patch antenna 14b.

As illustrated in FIG. 2(A), when the two patch antennas 14 constituting the subarray 140 are arranged in the X-axis direction, the distance between one of the two patch antennas 14 and the signal line 161 (the in-plane wiring portion 161a) is the same as the distance between the other of the two patch antennas 14 and the signal line 161. Thus, in the antenna module 100 illustrated in FIG. 2(A), a signal flowing through the signal line 161 affects the performance of the two patch antennas 14 equally.

In contrast, in the first modification in which the two patch antennas 14 (14a and 14b) constituting the subarray 140 are arranged in the Y-axis direction, the influence of a signal flowing through the signal line 161 exerted on the performance of the patch antenna 14a farther from the signal line 161 can be reduced. In other words, in the first modification, only one of the two patch antennas 14 is strongly affected by the signal line 161. This makes it possible to prevent the directivity of the entire subarray 140 from significantly deteriorating.

Alternatively, in the antenna module 100A according to the first modification, three or more patch antennas 14 may constitute the subarray 140. In this case, the plurality of patch antennas 14 constituting the subarray 140 may be arranged in the Y-axis direction. In any case, a configuration may be designed so that, when the dielectric substrate 131 is viewed in plan, the distance between a first patch antenna constituting the subarray 140 and the signal line 161 is different from the distance between a second patch antenna constituting the subarray 140 and the signal line 161.

### Second Modification

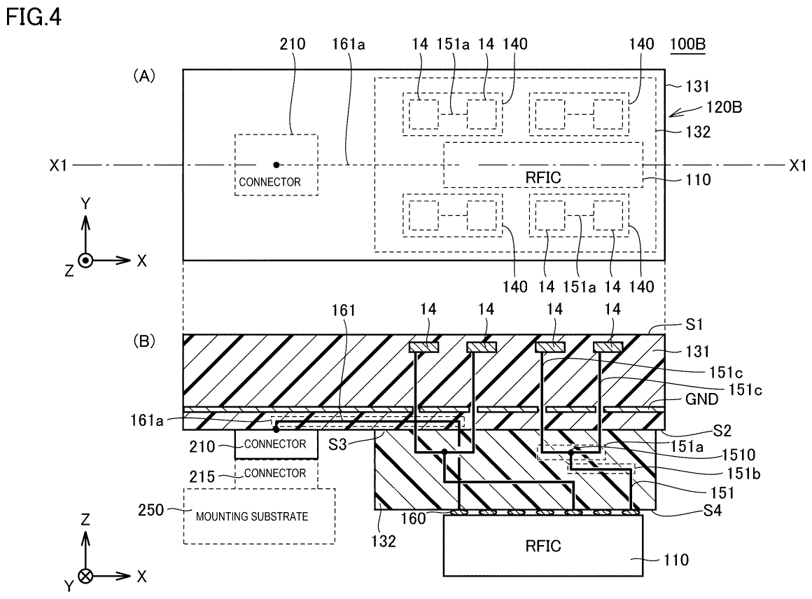

Next, a second modification of the first embodiment will be described. FIG. 4 is a diagram illustrating the second modification of the antenna module 100 according to the first embodiment. An antenna module 100B according to the second modification includes the RFIC 110 and an antenna device 120B.

In the antenna module 100B according to the second modification, the in-plane wiring portion 161a of the signal line 161 is disposed between the ground electrode GND and the substrate surface S2, as illustrated in FIG. 4(B).

In the antenna module 100 described above, the signal line 161 is present between the ground electrode GND and the substrate surface S1, as illustrated in FIG. 2(B). In contrast, in the antenna module 100B according to the second modification, the signal line 161 is absent between the ground electrode GND and the substrate surface S1. Thus, as compared with the antenna module 100, the antenna module 100B according to the second modification is capable of reducing the influence of a signal flowing through the signal line 161 exerted on the subarray 140.

The antenna module 100B has a configuration similar to that of the antenna module 100 except that the signal line 161 is absent between the ground electrode GND and the substrate surface S1.

In the antenna module 100B, as in the antenna module 100, the in-plane wiring portion 161a of the signal line 161 and the in-plane wiring portions 151a and 151b of the feed line 151 do not overlap each other when the dielectric substrate 131 is viewed in plan.

As described above, the electromagnetic coupling force between a signal flowing through the in-plane wiring portion 161a and a signal flowing through the in-plane wiring portions 151a and 151b is greater than the electromagnetic coupling force between a signal flowing through the in-plane wiring portion 161a and a signal flowing through a via wiring portion (for example, the branch lines 151c).

In the antenna module 100B according to the second modification, the ground electrode GND is not located between the in-plane wiring portion 161a and the in-plane wiring portions 151a and 151b, and thus the problem of electromagnetic coupling is larger than in the antenna module 100.

However, the in-plane wiring portion 161a and the in-plane wiring portions 151a and 151b that are prone to electromagnetic coupling do not overlap each other when the dielectric substrate 131 is viewed in plan. Thus, in the second modification, electromagnetic coupling can be reduced more effectively.

### Second Embodiment

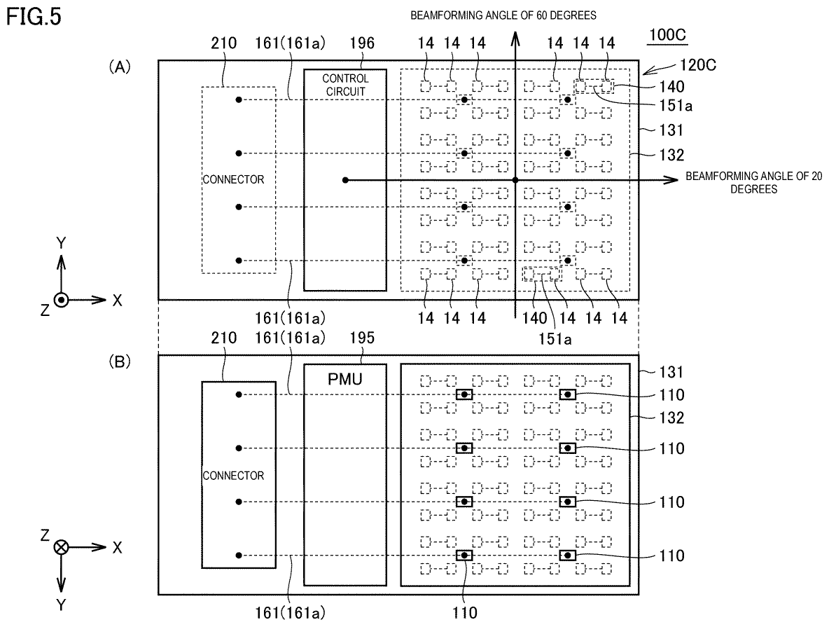

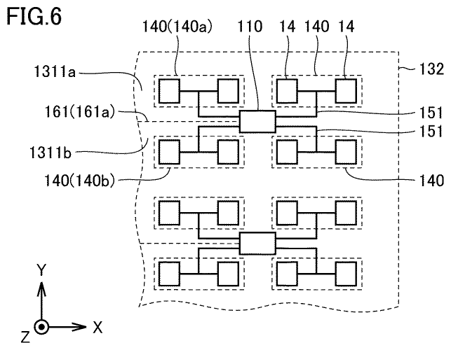

FIG. 5 is a plan view of an antenna module 100C according to a second embodiment. In particular, FIG. 5(A) is a front view and FIG. 5(B) is a rear view. FIG. 6 is a diagram illustrating a wiring manner of the feed lines 151 applied to the antenna module 100C illustrated in FIG. 5. The antenna module 100C according to the second embodiment includes RFICs 110 and an antenna device 120C.

The antenna module 100C according to the second embodiment includes the dielectric substrates 131 and 132 and the connector 210, similarly to the antenna module 100 according to the first embodiment. The antenna module 100C includes a plurality of subarrays 140 disposed in the dielectric substrate 131, and the RFICs 110 attached to the dielectric substrate 132, similarly to the antenna module 100.

Note that the antenna module 100C includes eight RFICs 110. As illustrated in FIG. 6, each RFIC 110 feeds electric power to four subarrays 140. Four feed lines 151 are connected to each RFIC 110. Each feed line 151 branches to extend to the two patch antennas 14 constituting the subarray 140. When the dielectric substrate 131 is viewed in plan, each RFIC 110 is disposed at a position surrounded by the four subarrays 140 to which the RFIC 110 feeds electric power.

Each RFIC 110 is connected to the connector 210 by the signal line 161. FIG. 5 illustrates the in-plane wiring portion 161a of the signal line 161, as in FIG. 2(A).

The antenna module 100C is different from the antenna module 100 in including a power management integrated unit (PMU) 195 and a control circuit 196. The PMU 195 is an example of a power supply circuit. The control circuit 196 may be a circuit for controlling active elements such as a switch and an amplifier circuit included in the RFIC 110. The control circuit 196 includes, for example, a control IC constituted by a digital circuit.

The control circuit 196 is disposed on a front surface of the dielectric substrate 131, and the PMU 195 is disposed on a rear surface of the dielectric substrate 131. The PMU 195 and the control circuit 196 are each an example of an electronic component.

The antenna module 100C has a configuration similar to that of the antenna module 100 except for the above-described differences.

### Beamforming

As illustrated in FIG. 5, an electronic component such as the control circuit 196 is present in the X-axis direction of each subarray 140. On the other hand, an electronic component is absent in the Y-axis direction of each subarray 140. Thus, the beam steering angle in the X-axis direction in which an electronic component is present is smaller than the beam steering angle in the Y-axis direction in which an electronic component is absent.

FIG. 5 illustrates angles regarding beamforming of the subarrays 140. The beamforming angle in the X-axis direction is, for example, 20 degrees. The beamforming angle in the Y-axis direction is, for example, 60 degrees.

In the case of disposing the antenna module 100C on a side surface of a structure, such as a utility pole, perpendicular to the ground, the X-axis direction of the antenna module 100C may match the vertical direction of the structure. Accordingly, the beam steering angle in the horizontal direction of the structure can be made greater than the beam steering angle in the vertical direction of the structure.

### Relationship Between Subarray 140 and RFIC 110

As illustrated in FIG. 6, when the dielectric substrate 131 is viewed in plan, the RFIC 110 is disposed at a position surrounded by the four subarrays 140 to which the RFIC 110 feeds electric power. Here, among the four subarrays 140, the two subarrays 140 arranged in the Y-axis direction are referred to as a “subarray 140a” and a “subarray 140b”.

As illustrated in FIG. 6, the region where the subarrays 140 are disposed includes a region 1311a and a region 1311b separated by the signal line 161.

When the dielectric substrate 131 is viewed in plan, the subarray 140a is disposed in the region 1311a of the region 1311a and the region 1311b separated by the signal line 161, and the subarray 140b is disposed in the region 1311b. When the dielectric substrate 131 is viewed in plan, the feed line 151 includes a first feed line extending in the region 1311a and connected to the subarray 140a and a second feed line extending in the region 1311b and connected to the subarray 140b.

### Modification

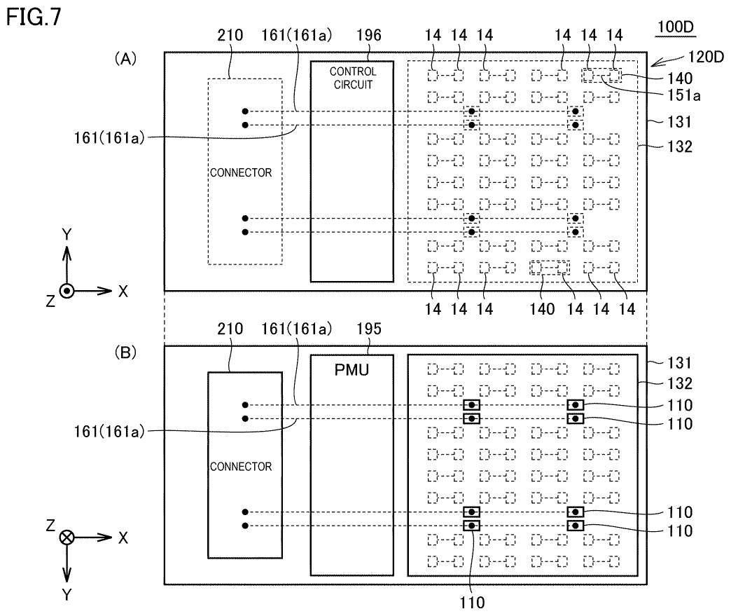

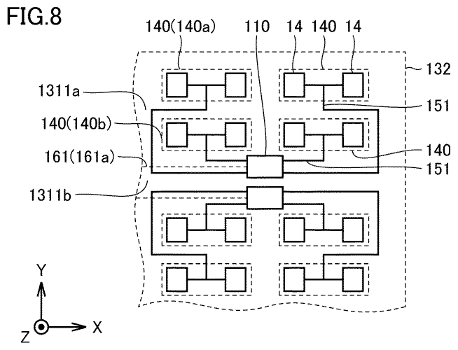

FIG. 7 is a diagram illustrating a modification of the antenna module 100C according to the second embodiment. In particular, FIG. 7(A) is a front view and FIG. 7(B) is a rear view. FIG. 8 is a diagram illustrating a wiring manner of the feed lines 151 applied to an antenna module 100D illustrated in FIG. 7. The antenna module 100D according to the modification includes RFICs 110 and an antenna device 120D.

The antenna module 100D is different from the antenna module 100C in the positions of the four subarrays 140 to which the RFIC 110 feeds electric power. In the antenna module 100D, when the dielectric substrate 131 is viewed in plan, the four subarrays 140 to which electric power is to be fed are disposed in the region 1311a of the two regions 1311a and 1311b separated by the signal line 161.

When the dielectric substrate 131 is viewed in plan, the subarray 140a is disposed in the region 1311a of the region 1311a and the region 1311b separated by the signal line 161, and also the subarray 140b is disposed in the region 1311a. When the dielectric substrate 131 is viewed in plan, the feed line 151 includes a first feed line extending in the region 1311a and connected to the subarray 140a and a second feed line extending in the region 1311a and connected to the subarray 140b.

### Comparison Between Antenna Module 100C and Antenna Module 100D

When the antenna module 100C and the antenna module 100D are compared with each other, the wiring length from the RFIC 110 to the subarrays 140 is shorter in the antenna module 100C than in the antenna module 100D. Thus, transmission loss is lower in the antenna module 100C than in the antenna module 100D. As a result, antenna gain can be increased.

When the antenna module 100C and the antenna module 100D are compared with each other, both are different from each other in that, in the antenna module 100C, one RFIC 110 is disposed at each of eight locations, whereas in the antenna module 100D, two RFICs 110 are disposed at each of four locations. In the case of disposing two RFICs 110 at each of four locations, as compared with the case of disposing one RFIC 110 at each of eight locations, the number of subarrays affected by the signal line 161 is smaller, and thus degradation of the directivity of the entire array antenna (deviation of the directivity from the zenith direction of the substrate) can be suppressed.

### Aspects

It is to be understood by those skilled in the art that the above-described embodiments are specific examples of the following aspects.

(First aspect) An antenna module according to an aspect includes a substrate, a ground electrode opposed to a first main surface and a second main surface opposed to each other of the substrate, a first subarray opposed to the ground electrode and disposed on the first main surface side relative to the ground electrode, a feed circuit disposed on the second main surface side relative to the ground electrode, a feed line connecting the feed circuit and the first subarray, an external connection terminal, and a signal line connecting the feed circuit and the external connection terminal, in which the first subarray is constituted by a plurality of patch antennas, when viewed in plan in a first direction which is a normal direction of the substrate, the external connection terminal is disposed at a position that does not overlap the first subarray or the feed circuit, when viewed in plan in a second direction orthogonal to the first direction, at least a part of the signal line is disposed between one or more of the plurality of patch antennas and the ground electrode, and when viewed in plan in the first direction, the signal line does not overlap the first subarray.

(Second aspect) The antenna module according to the first aspect, in which the plurality of patch antennas include a first patch antenna and a second patch antenna, and when viewed in plan in the first direction, a distance between the first patch antenna and the signal line is different from a distance between the second patch antenna and the signal line.

(Third aspect) The antenna module according to the first aspect or the second aspect, in which a frequency band of a signal that flows through the signal line is lower than a frequency band supported by the plurality of patch antennas.

(Fourth aspect) The antenna module according to any one of the first aspect to the third aspect, further including a second subarray, in which when viewed in plan in the first direction, the signal line is disposed between the first subarray and the second subarray.

(Fifth aspect) The antenna module according to any one of the first aspect to the fourth aspect, in which the feed line includes branch lines that branch out at a branch point, the branch point is located on the second main surface side relative to the ground electrode, and a portion on the second main surface side relative to the ground electrode in the substrate has a lower dielectric loss tangent than a portion on the first main surface side relative to the ground electrode.

(Sixth aspect) The antenna module according to any one of the first aspect to the fourth aspect, in which the feed line includes branch lines that branch out at a branch point, and when viewed in plan in the first direction, the branch lines do not overlap the signal line.

(Seventh Aspect) The antenna module according to any one of the first aspect to the sixth aspect, in which the signal line and the feed line each include an in-plane wiring portion extending in the second direction, and when viewed in plan in the second direction, the in-plane wiring portion of the signal line does not overlap the in-plane wiring portion of the feed line.

(Eighth aspect) The antenna module according to any one of the first aspect to the sixth aspect, in which the signal line and the feed line each include an in-plane wiring portion extending in the second direction, when viewed in plan in the second direction, the in-plane wiring portion of the signal line and the in-plane wiring portion of the feed line are both disposed in a portion on the first main surface side relative to the ground electrode in the substrate or disposed in a portion on the second main surface side relative to the ground electrode, and when viewed in plan in the first direction, the in-plane wiring portion of the signal line does not overlap the in-plane wiring portion of the feed line.

(Ninth aspect) The antenna module according to any one of the first aspect to the sixth aspect, in which the signal line and the feed line each include an in-plane wiring portion extending in the second direction, and when viewed in plan in the second direction, the ground electrode is disposed between the in-plane wiring portion of the signal line and the in-plane wiring portion of the feed line.

(Tenth aspect) The antenna module according to the first aspect, further including a second subarray, in which when viewed in plan in the first direction, the first subarray is disposed in, of a first region and a second region separated by the signal line, the first region, and the second subarray is disposed in the second region, and when viewed in plan in the first direction, the feed line includes a first feed line extending in the first region and connected to the first subarray and a second feed line extending in the second region and connected to the second subarray.

(Eleventh aspect) The antenna module according to the first aspect, further including a second subarray, in which when viewed in plan in the first direction, the first subarray and the second subarray are disposed in, of a first region and a second region separated by the signal line, the first region, and the feed line includes a first feed line extending in the first region and connected to the first subarray and a second feed line extending in the first region and connected to the second subarray.

(Twelfth aspect) A communication device according to another aspect includes the antenna module according to any one of the first aspect to the eleventh aspect.

The embodiments disclosed herein are to be considered illustrative and not restrictive in every respect. The scope of the present invention is defined not by the foregoing description of the embodiments but by the claims, and is intended to encompass all changes within the meaning and scope equivalent to the claims.

### REFERENCE SIGNS LIST

10 communication device
14, 14a, 14b patch antenna
100, 100A-100D antenna module
110 RFIC
111A-111D, 113A-113D, 117 switch
112AR-112DR low-noise amplifier
112AT-112DT power amplifier
114A-114D attenuator
115A-115D phase shifter
116 signal combiner/splitter
118 mixer
119 amplifier circuit
120, 120A-120D antenna device
131, 132 dielectric substrate
140, 140a, 140b subarray
151 feed line
151a, 151b, 161a in-plane wiring portion
151c branch line
160 solder bump
161 signal line
195 PMU (power supply circuit)
196 control circuit
200 BBIC
210, 215 connector
250 mounting substrate
1311a, 1311b region
1510 branch point
GND ground electrode
S1, S2, S3, S4 substrate surface

1. An antenna module comprising:
a substrate including a first main surface and a second main surface;
a ground electrode opposed to the first main surface and the second main surface of the substrate;
a first subarray opposed to the ground electrode and disposed on a first main surface side relative to the ground electrode, the first subarray including a plurality of patch antennas,
when viewed in plan in a first direction which is a;
feed circuitry disposed on a second main surface side relative to the ground electrode;
a feed line connecting the feed circuitry and the first subarray;
an external connection terminal; and
a signal line connecting the feed circuitry and the external connection terminal, wherein
when viewed in plan in a first direction which is a normal direction of the substrate, the external connection terminal does not overlap the first subarray or the feed circuitry,
when viewed in plan in a second direction orthogonal to the first direction, at least a part of the signal line is disposed between one or more of the plurality of patch antennas and the ground electrode, and
when viewed in plan in the first direction, the signal line does not overlap the first subarray.

2. The antenna module according to claim 1, wherein
the plurality of patch antennas include a first patch antenna and a second patch antenna, and
when viewed in plan in the first direction, a distance between the first patch antenna and the signal line is different from a distance between the second patch antenna and the signal line.

3. The antenna module according to claim 1, wherein a frequency band of a signal that flows through the signal line is lower than a frequency band supported by the plurality of patch antennas.

4. The antenna module according to claim 1, further comprising:
a second subarray, wherein
when viewed in plan in the first direction, the signal line is disposed between the first subarray and the second subarray.

5. The antenna module according to claim 1, wherein
the feed line includes branch lines that branch out at a branch point,
the branch point is located on the second main surface side relative to the ground electrode, and
a portion on the second main surface side relative to the ground electrode in the substrate has a lower dielectric loss tangent than a portion on the first main surface side relative to the ground electrode.

6. The antenna module according to claim 1, wherein
the feed line includes branch lines that branch out at a branch point, and
when viewed in plan in the first direction, the branch lines do not overlap the signal line.

7. The antenna module according to claim 1, wherein
the signal line and the feed line each include an in-plane wiring portion extending in the second direction, and
when viewed in plan in the second direction, the in-plane wiring portion of the signal line does not overlap the in-plane wiring portion of the feed line.

8. The antenna module according to claim 1, wherein
the signal line and the feed line each include an in-plane wiring portion extending in the second direction,
when viewed in plan in the second direction, the in-plane wiring portion of the signal line and the in-plane wiring portion of the feed line are both disposed in a portion on the first main surface side relative to the ground electrode in the substrate or disposed in a portion on the second main surface side relative to the ground electrode, and
when viewed in plan in the first direction, the in-plane wiring portion of the signal line does not overlap the in-plane wiring portion of the feed line.

9. The antenna module according to claim 1, wherein
the signal line and the feed line each include an in-plane wiring portion extending in the second direction, and
when viewed in plan in the second direction, the ground electrode is disposed between the in-plane wiring portion of the signal line and the in-plane wiring portion of the feed line.

10. The antenna module according to claim 1, further comprising:
a second subarray, wherein
when viewed in plan in the first direction, the first subarray is disposed in, of a first region and a second region separated by the signal line, the first region, and the second subarray is disposed in the second region, and
when viewed in plan in the first direction, the feed line includes a first feed line extending in the first region and connected to the first subarray and a second feed line extending in the second region and connected to the second subarray.

11. The antenna module according to claim 1, further comprising:
a second subarray, wherein
when viewed in plan in the first direction, the first subarray and the second subarray are disposed in, of a first region and a second region separated by the signal line, the first region, and
the feed line includes a first feed line extending in the first region and connected to the first subarray and a second feed line extending in the first region and connected to the second subarray.

12. The antenna module according to claim 1, wherein, when viewed in plan in the first direction, the signal line is disposed between the first subarray and a second subarray.

13. The antenna module according to claim 1, wherein a frequency band of a radio frequency (RF) signal flowing through the feed line is a millimeter-wave band.

14. The antenna module according to claim 1, further comprising power management circuitry on the second main surface of the substrate.

15. The antenna module according to claim 1, wherein the feed circuitry comprises a radio frequency integrated circuit (RFIC) connected to the second main surface.

16. The antenna module according to claim 1, wherein the first subarray is arranged as a 1×2, 2×1, or 2×2 matrix of patch antennas.

17. A communication device comprising:
the antenna module according to claim 1, and
processing circuitry configured to process signals received from the external connection terminal.

18. An antenna module comprising:
a substrate including a first dielectric layer and a second dielectric layer;
a ground electrode disposed between the first dielectric layer and the second dielectric layer;
a plurality of antenna subarrays disposed within the first dielectric layer;
processing circuitry disposed on a surface of the second dielectric layer;
a feed line connecting the processing circuitry and the plurality of antenna subarrays, the feed line including a branch point disposed within the second dielectric layer; and
a signal line connecting the processing circuitry and an external terminal;
wherein a dielectric loss tangent of the second dielectric layer is lower than a dielectric loss tangent of the first dielectric layer.

19. The antenna module according to claim 18, wherein the feed line includes an in-plane wiring portion extending parallel to the ground electrode and a through-hole wiring portion extending through the ground electrode, and wherein the branch point is located in the in-plane wiring portion.

20. The antenna module according to claim 18, wherein the processing circuitry is configured to individually control a phase of a radio frequency (RF) signal supplied to each of the plurality of antenna subarrays.
